(19) United States
(12) Patent Application Publication
(10) Pub. No.: US 2019/0251744 A1
(43) Pub. Date: Aug. 15, 2019

(54) SYSTEM AND METHOD FOR SEARCHING 3D MODELS USING 2D IMAGES

(71) Applicant: Express Search, Inc., Springfield, VA (US)

(72) Inventor: Cristopher Flagg, Springfield, VA (US)

(73) Assignee: Express Search, Inc., Springfield, VA (US)

(21) Appl. No.: 16/105,392

(22) Filed: Aug. 20, 2018

Related U.S. Application Data
(60) Provisional application No. 62/629,449, filed on Feb. 12, 2018.

(51) Int. Cl. G06T 17/10; G06F 17/30; G06K 9/00; G06K 9/62; G06T 19/20

(52) U.S. Cl. CPC G06T 17/10; G06F 17/30247; G06T 2219/2004; G06K 9/6215; G06T 19/20; G06K 9/00523

(57) ABSTRACT

The methods, systems, and processes described herein enable one to use 2D images to construct a 3D model, perform a search for similar stored models, and return results based on the similarity of the 3D model to stored models. This is accomplished, for example, by receiving a query of 2D images, generating a 3D model from the 2D images, comparing the 3D model to archived 3D models, ranking the comparisons, and responding to the query based on the ranked results.

### PRIORITY

The present application claims priority to U.S. Provisional Patent Application No. 62/629,449, filed Feb. 12, 2018, the contents of which are incorporated herein in their entirety.

### BACKGROUND

### Technical Field

The present disclosure relates to searching three-dimensional (“3D”) models, and more specifically to using multiple two-dimensional (“2D”) images to construct a 3D model and search for the 3D model.

### INTRODUCTION

A common representation of a 3D object is a multi-view collection of 2D images showing the object from multiple angles. This technique is commonly used with document repositories, such as engineering drawings, as well as governmental repositories, such as design patents and 3D trademarks, where the original physical artifact is not available. When the original physical artifact is modeled as a set of images, the resulting multi-view collection of images may be indexed and retrieved using traditional image search techniques. As a result, massive repositories of multi-view collections have been compiled. For example, many government databases representing patents, industrial designs, and trademarks represent 3D objects as a set of images. For a design patent issued in the United States Patent and Trademark Office “[t]he drawings or photographs should contain a sufficient number of views to completely disclose the appearance of the claimed design, i.e., front, rear, right and left sides, top and bottom.” While these sets of drawings often include views for exploded views, isometric views, and alternate positions, the minimum set of six views is required. Other countries have similar requirements for filing for protection of industrial designs.

However, when it comes to searching these databases of 2D images to determine if a 3D model has been previously trademarked, patented, or designed, the searching is, at present, ineffective. Such searching must be performed by a human being, with the results being a subjective result based on how that human being compares the 2D images in the database to another object. The searching is slow, based on the speed at which the human being can view the 2D images, convert them into a 3D model in their mind, and compare the model in their mind with the object in question. Finally, the results can be inaccurate based on distinct orientations of the 2D images, the 3D model the human produces in their mind, and/or the object in question.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

An exemplary method performed according to this disclosure can include: receiving a query, the query comprising a plurality of two-dimensional images, each two-dimensional image in the plurality of two-dimensional images having a distinct multi-view perspective; generating, at a processor configured to generate a three-dimensional model from two-dimensional images, for each two-dimensional image in the plurality of two-dimensional images, a silhouette, to yield a plurality of silhouettes; combining, via the processor, the silhouettes using the distinct multi-view perspective of each two-dimensional image, to yield a three-dimensional model; comparing, via the processor, the three-dimensional model to archived three-dimensional models, to yield a comparison; and ranking, via the processor and based on the comparison, the archived three-dimensional models by similarity to the three-dimensional model, to yield ranked similarity results; and responding to the query with the ranked similarity results.

An exemplary system configured according to this disclosure can include: a processor configured to generate a three-dimensional model from two-dimensional images; and a computer-readable storage medium having instructions stored which, when executed by the processor, cause the processor to perform operations comprising: receiving a query, the query comprising a plurality of two-dimensional images, each two-dimensional image in the plurality of two-dimensional images having a distinct multi-view perspective; generating, for each two-dimensional image in the plurality of two-dimensional images, a silhouette, to yield a plurality of silhouettes; combining the silhouettes using the distinct multi-view perspective of each two-dimensional image, to yield a three-dimensional model; comparing the three-dimensional model to archived three-dimensional models, to yield a comparison; and ranking, based on the comparison, the archived three-dimensional models by similarity to the three-dimensional model, to yield ranked similarity results; and responding to the query with the ranked similarity results.

An exemplary non-transitory computer-readable storage medium configured as disclosed herein can include instructions stored which, when executed by a processor configured to generate a three-dimensional model from two-dimensional images, cause the processor to perform operations such as: receiving a query, the query comprising a plurality of two-dimensional images, each two-dimensional image in the plurality of two-dimensional images having a distinct multi-view perspective; generating, for each two-dimensional image in the plurality of two-dimensional images, a silhouette, to yield a plurality of silhouettes; combining the silhouettes using the distinct multi-view perspective of each two-dimensional image, to yield a three-dimensional model; comparing the three-dimensional model to archived three-dimensional models, to yield a comparison; and ranking, based on the comparison, the archived three-dimensional models by similarity to the three-dimensional model, to yield ranked similarity results; and responding to the query with the ranked similarity results.

### BRIEF DESCRIPTION OF THE DRAWINGS

FIG. 1 illustrates an exemplary method according to this disclosure;

FIG. 2A illustrates a silhouette of a side view;

FIG. 2B illustrates an extrusion of the silhouette;

FIG. 2C illustrates intersectioned extruded silhouettes;

FIG. 2D illustrates a final volume using the intersectioned extruded silhouettes;

FIG. 3A illustrates projected faces and a height map;

FIG. 3B illustrates slices at a top pixel;

FIG. 3C illustrates slices projected onto a top face;

FIG. 3D illustrates resulting areas of interest on the top face;

FIG. 3E illustrates a height map modified based on features in areas of interest;

FIG. 3F illustrates slices at a lower pixel without changes to height map;

FIG. 4A illustrates a slice at a top face;

FIG. 4B illustrates an area of interest;

FIG. 4C illustrates an updated height map;

FIG. 5 illustrates an exemplary slice of a pyramid;

FIG. 6A illustrates an original 3D model;

FIG. 6B illustrates multi-view images of the original 3D model;

FIG. 7A illustrates an original 3D model;

FIG. 7B illustrates a multi-view representation;

FIG. 7C illustrates silhouettes of the multi-view representation;

FIG. 7D illustrates a reconstructed 3D model;

FIG. 8 illustrates another exemplary method; and

FIG. 9 illustrates an exemplary computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

At present, searching for 3D objects is performed in one of two ways: either performing a 2D image comparison, or a 3D model comparison to other 3D models. However, the technical ability to search 3D models based on multiple 2D images (multiple views) of the associated object is not currently performed using computer technology, and is manually performed by people looking at the 2D images, forming a 3D model in their minds eye, and comparing that 3D model to other 3D models represented by 2D images. This process is inaccurate, inefficient, and labor intensive.

The methods, systems, and processes described herein enable one to use 2D images to construct a 3D model, perform a search for similar stored models, and return results based on the similarity of the 3D model to stored models.

While valid representations of an object, 2D renderings of objects do not typically provide enough detail to accurately reconstruct a 3D object. Engineering drawings provide breakout diagrams and hidden lines to better represent the 3D object in multiple views. When the views are lacking in hidden line detail, important information about the final 3D object is lost.

A silhouette, as defined herein, can be any closed, external boundary of a two dimensional image, where everything internal to that boundary (including any or all details, shading, coloring, or contours) is present.

Patent drawings utilized in design patents typically present pictures of the object from six views as well as an isometric view for perspective. These images do not use hidden lines or other conventions typically used in engineering drawings. As a result, it is more difficult to generate a 3D object from these multiple views.

When identifying 3D structures from images, one approach is to extract features from a set of multi-view images generated from the 3D object and create 2D image feature descriptors using SIFT (Scale Invariant Feature Transform), which detects and describes local features in images, and store the extracted feature descriptors. Any 2D image would have features extracted and compared against the features within the database. The resulting 3D model would be closest to the 2D image presented. While technically not a reconstruction, this method produces a 3D model based on 2D input for a known set of models.

2D images may be created from different viewpoints of a 3D model and then a Siamese neural network (a class of neural network architectures that contain two or more identical subnetworks where the subnetworks have the same configuration with the same parameters and weights. Parameter updating is mirrored across both subnetworks.) may be trained to match sketches of the object and the 2D rendering of the object to a label, producing a neural network that can images against renderings to classify the two inputs as ‘same’ or ‘different’. The 3D model could be obtained by finding the closest match to an existing model in a database.

The isometric view of a planar object may be transformed into a 3D object by inferring hidden topological structures. Each hidden face of the image is assumed to correspond to a face of the 3D object, producing an object with symmetry. Multiple possible hidden structures for a shape are evaluated and the shape with the minimum standard deviation of all angles is considered to be the best candidate 3D construction. Unassisted machine interpretation of a single line drawing of an engineering object (with hidden lines removed) may be accomplished using linear systems in which the unknowns are, for example, the depth coordinates of junctions in a line drawing.

Solid model reconstruction from 2D sectional views may be derived from a volume-based approach. The use of a volume-based approach may handle different types of sectional views. Object silhouette vertices are used to segment objects.

3D reconstructions may be produced from 2D drawings, rather than renderings of the model from different images. Silhouettes can be used to make the wireframe models of the 3D assemblies, with 2D vertices and edges which can exist as silhouettes are drawn in the 2D drawings. These are called silhouette 2D vertices and edges, and can be used to create simple shapes that may be combined to create the final object.

Outer profiles of isometric drawing objects may be used to extrude the parts before further refining the object. These views can then be intersected to produce a final volume.

The silhouette and contour area method may be used to extrude individual faces of a drawing object, then intersect the extruded faces into the final object. While this method uses multiple views to reconstruct the object, hidden lines from the engineering drawings can be used to create the final image. In such cases, subtraction operations can be used to remove interior sections not identified from hidden lines.

This disclosure uses the details in the views of 2D images to progressively construct a height map of the intersecting view in a manner that creates a 3D object that is more detailed than simply using the silhouettes alone. As a result, features such as cylinders that would normally not be accurately reproduced (using prior techniques) are properly generated.

### First Exemplary Method

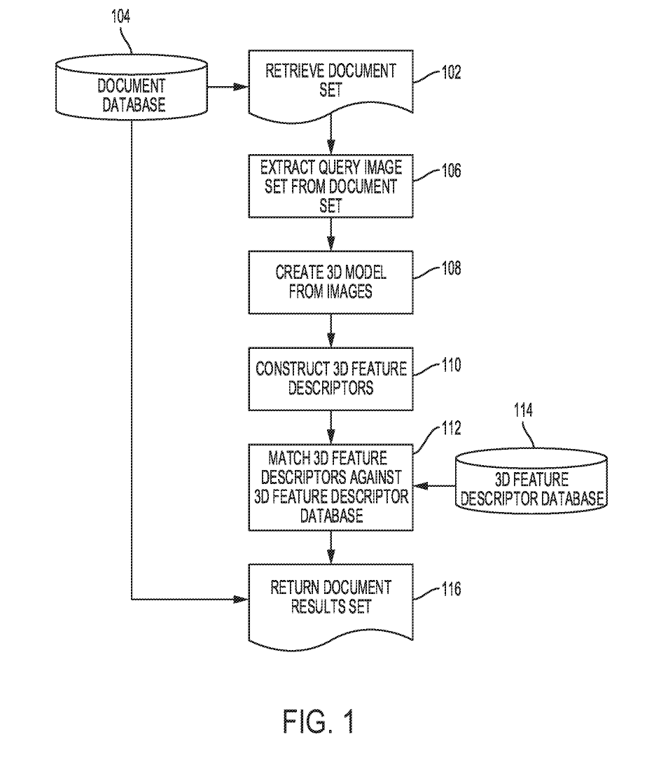

FIG. 1 illustrates a first exemplary method for performing the methods and concepts disclosed herein. In this example, a document database 104 exists which contains text, images, mixed media documents, and/or other documents/data. The document database 104 can contain 3D models, but can also contain 2D images or other data. The data within the document database 104, or a portion of the data within the document database, is retrieved (a document set) (102), and a query image set is extracted from the document set (106). The system creates a 3D model from images received as part of the query image set (108), and the system constructs 3D feature descriptors of features identified on the 3D model (110). The system matches the 3D feature descriptors identified against archived 3D feature descriptors (112) stored in a 3D feature descriptors database 114. The results of the matching are returned to the user initiating the query as a documents results set (116), which can incorporate data directly from the document database 104.

Various approaches for performing this method and others are disclosed herein. These approaches (and aspects of these approaches) can be combined as needed for a particular circumstance or environment. In a first approach, the silhouettes of the line drawings are extracted, extruded, and intersected. This produces results that are recognizable as the final 3D object being modeled. Specific surface details such as shading, intensity, and surface features may be added back onto the object. A second approach utilizes a progressive scan of front and side images to identify areas of interest in the top region. This information fills in a height map of the object to create a final volume.

### Reconstruction from Silhouettes

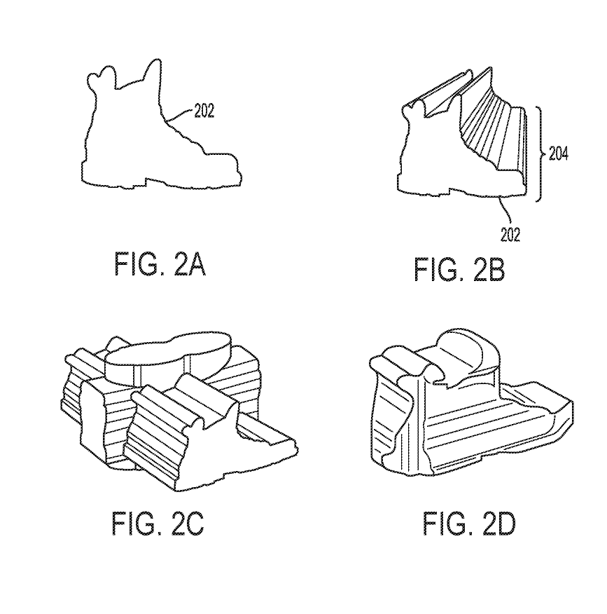

The silhouette of an image provides the outer most bounds of the object. It is guaranteed that no part of the object will extend beyond this region. Given this observation, a crude version of the 3D object can be generated by combining multiple silhouette images based on the 2D views, as illustrated in FIGS. 2A-2D.

Given an object represented by drawings having different views, it is possible to choose a front, side and top view of the object. For example, FIG. 2A illustrates a silhouette 202 of a side view of a shoe. Because this portion of the method only considers the silhouette of the object, and the silhouette of the bottom view is the mirror image of the top view, the silhouette of the bottom view can be ignored. Silhouettes of these three views can then be linearly extruded into 3D surfaces. FIG. 2B illustrates an extrusion 204 of the silhouette 202 of FIG. 2A. Each of these surfaces of the extrude silhouette represents the possible 3D object as seen from a respective face. When three or more extruded objects are intersected, as illustrated in FIG. 2C, a new volume can be created that represents the 3D object as a combination of the maximum possible outlines of the actual shape. FIG. 2D illustrates a final volume of the shoe using the intersectioned extruded silhouettes.

The resulting 3D shape is, however, only a crude representation of the final object. Contours and gradients that occur within the shape can be lost. One example is a cylinder on top of a square. From the sides, the cylinder looks like a rectangle. Because the top view is only represented by the silhouette, the circular cross section of the cylinder is lost, and the resulting shape is a rectangle on top of a square. Likewise, because the details within the top projection are lost, the specific features that would identify the cylinder from the top view may be lost.

### Feature Extraction and Height Map

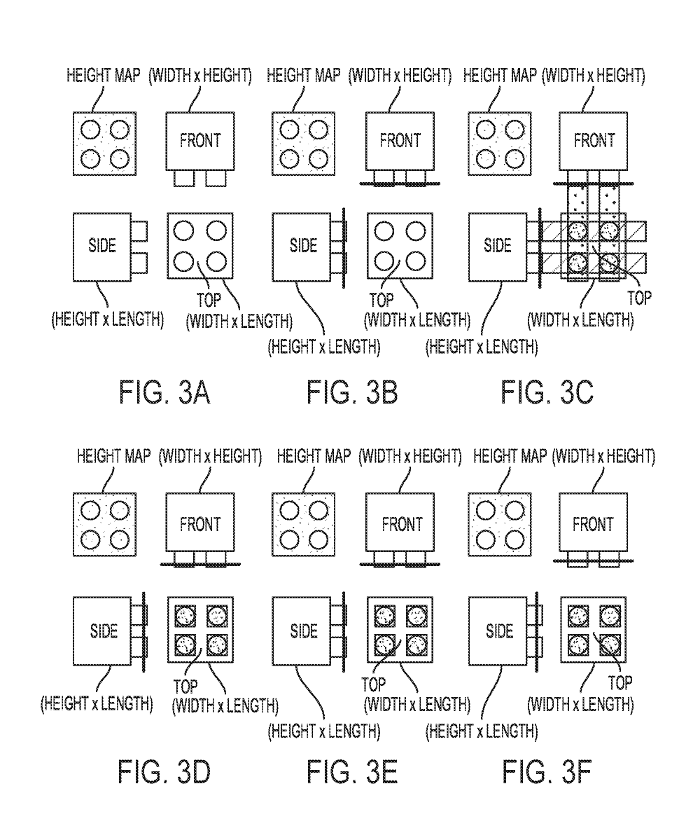

FIGS. 3A-3F illustrate exemplary stages of generating a height map from a top projection. In order to utilize information provided by contours and features located in the top image, it is important to first recognize the inter-relationship of the front, side, and top projections, as illustrated in FIG. 3A. The front projection is an image whose upper right corner represents a point of maximum height and maximum width in the 3D object. The side projection is an image whose upper right corner is a point with the maximum height and maximum length in the 3D object. Because the top projection relates directly to the front and side projections, the lower right corner of this image is a point with maximum length and maximum width.

Having established the geometry of the images, the relationship of these points may be exploited. A point in the top row of the front image is at the maximum height for an object. A point in the top row and a 4th column of the front image could map to any point in the 4th row of the top image. A point in the top row of the side image is also at the maximum height for an object. A point in the top row and a 4th column of the side image could map to any point in the 4th column of the top image.

The silhouette of the front image provides a maximum boundary for the front image. Any points inside the silhouette are within the 3D object and any points outside the silhouette are not in the 3D object. Taking a row from the front silhouetted provides a slice of the final 3D object. If the slice of the front silhouette is from the top row, any points in the slice that are inside the silhouette are guaranteed to be part of the final 3D object and located at the maximum height.

These points in the top row slice of the front silhouette correspond to at least one, but possibly many, points that are within the top silhouette (as illustrated in FIG. 3B). These points from the front silhouette are projected as lines/rectangles across the length of the top image. If the slice of the top row of the side silhouette is also taken, points inside the side silhouette are projected as line/rectangles across the width of the top image (as illustrated in FIG. 3C). The intersection of these projections creates areas of interest in the top image where a point from the front image could match a point from the side image.

In order to gain feature information from the top image, the image can be decomposed into contours and shapes. Any closed shape in the top view represent edges in the 3D object. If the areas of interest from the front and side views match any contours, then it is likely that the contour is the top projection of those views (as illustrated in FIG. 3D). In this way, the top of a cylinder may be identified as a circle because the projections from the front and side silhouettes match the circular feature on the top images (As illustrated in FIG. 3E).

Because a feature match has been detected, the feature can be leveraged. Consider the example of a slice taken from a specific height in the front and side images. A resulting match in the top image must also be at that height. Likewise, a height map of the top image may be constructed. This height map can represent the height of the matched pixels. If an identified object in the top projection is detected at the highest point of the top projection, the height map at the location of the object must be at the maximum height. As slices are taken at progressively lower heights in the front and side silhouettes (as illustrated in FIG. 3F), the matched features in the height map may be colored.

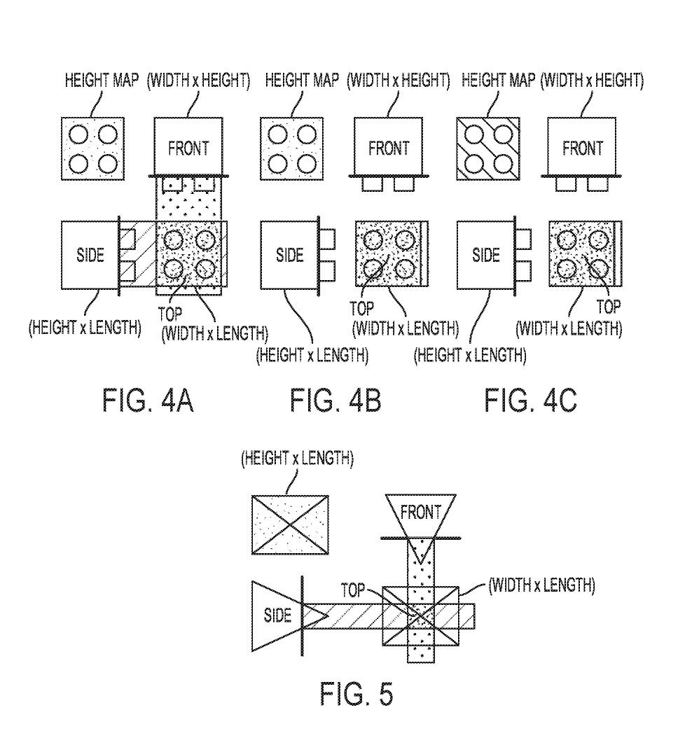

FIGS. 4A-4C illustrate exemplary matching of a new feature at a lower slice. Areas in the height map that are uncolored can represent parts of the 3D object that have not yet been analyzed. As new features are encountered, the heights at which these features are found can provide the height values of the height map, which in turn can be updated. Because the silhouette of the top image is the maximum boundary of the top image, this guarantees that once all of the slices from the highest point to the lowest point have been analyzed an entirety of the height map will have been considered.

For example, FIG. 4A illustrates a slice at a top face with known features, FIG. 4B illustrates an area of interest at a lower slice, and FIG. 4C illustrates an updated height map, with the height map changed. There are several cases to consider when matching features in the top image to the slices from the front and side silhouettes:

(1) Exact Matching of Feature and Area of Interest: In the case of the feature exactly matching the area of interest, it is known that at this height that shape is exactly matched. This provides a direct mapping of the feature to the height map.

(2) Partial Matching of Feature and Area of Interest: If the area of interest contains part of a feature, then only the part of that feature that has not already been colored in the height map exists at this level. This creates a gradient as the area of interest moves along the feature. An example of this would be a pyramid (FIG. 5). The top point of the pyramid is at the highest point of the 3D object. As the slice moves lower down the object, the area of interest will capture portions of each face of the pyramid. The result is a gradient in the height map that represents each face of the pyramid.

(3) No Matching of Feature and Area of Interest: If the area of interest is entirely within a feature, one can draw several conclusions. First, since the silhouettes from the front and side of the object put points at the extremes of the object, there has to be a point there. Secondly, it can be assumed that there is a curved surface that relates to the object at this point, since no edge lines are drawn. Finally, if the feature were shrunk to fit inside the area of interest, this would be the portion of the feature at this height. An example would be a sphere, which projects circles for all three faces. At a slice ¾ of the way down the front and side silhouettes, the area of interest would really be capturing the circular top feature shrunk to the size of the area of interest.

Finally, the examples provided can create a single height map based on the top image using the front and side silhouettes. There are four possible combinations of sides (out of the six total projections) that could match to the top image. As a result, 24 total height maps can be generated from a set of six projections. Each of these height maps captures information about from the image and silhouettes. The intersection of these 24 height maps creates the final 3D volume.

Previous attempts to generate 3D models from 2D projections have had success utilizing engineering drawings with hidden lines. However, when hidden lines are not available, such as with design patents, those previous methods miss vital details in the construction of the final models.

Additionally, those prior methods cannot accurately handle cases where curved surfaces are employed. By using silhouettes to generate coarse 3D models, more detailed maps can be created from the same images.

Representing a physical object as a collection of images was an acceptable format when the total number of documents were small in number and reviewed manually. As the number of documents increases the ability to manually retrieve relevant documents becomes more difficult.

Automated methods have been attempted to search these documents by first isolating the representative images in the documents and then applying image search techniques to create a set of features for each document that may be indexed and searched against. These features are constructed using standard techniques (such as SIFT, SURF (Speeded Up Robust Features), and Fourier Transform). Given this technology, searching for physical objects can be reduced to an image search, provided the images adhere to the same standards. However, it is not possible to search across collections where the image submission requirements are different, such as when the images vary in orientation.

3D models from images may be constructed through a combination of geometric matching and of semantic/functional analysis of each view. This is typically taken from vertex and face reconstruction from multiple engineering drawings. This approach looks to combine features to form the image with extruded volumes which are estimated from the drawings.

By applying 3D modeling to the collections of images it is possible to recreate a version of the original object. A proper selection of the views presented of the object may be aligned and used to reconstruct the original object. This provides several advantages when attempting to retrieve information across collections. In the context of image searching, the views required for a differing collection may be generated. Once the object is reconstructed it may be viewed from any angle and the required views may be generated. Secondly, the reconstructed models may now be compared against existing 3D collections. More specifically, 3D search techniques may now be applied to the models allowing intra-collection searching across different 3D model databases. Inter-collection searching may be improved by reconstructing all models within the collection and searching via 3D model features. That is, if the database or collection contains multi-view, 2D images, of objects (such as the U.S. Patent and Trademark Office design patent database), 3D models of the respective objects can be created from the 2D images, then used for comparisons.

### Constructing 3D Models from 2D Images

As discussed above, the outer profiles of isometric drawing objects may be extruded before further refining the object. These views are then intersected to produce a final volume.

### 2D Image Searching

Design patent image retrieval may use a method based on shape and color features. N-moment invariant features from color images are indexed. N-moment invariant features are extracted from a query image and compared against this database.

Multiple 2D feature descriptors may be used in 2D image retrieval. Some methods include SIFT, SURF, ORB (Oriented FAST and rotated BRIEF), Block-wise Dense SIFT (Block-DSIFT), Pyramid Histograms of Orientation Gradients (PHOG), GIST descriptor (a context-based scene recognition algorithm), Discrete Fourier transform (DFT), and other descriptors as image features. Key properties of feature descriptors are invariance and discriminability. The feature descriptors should be robust to variance in the image, such as scaling, rotating in the image plane, and 3D rotations. The feature descriptors should also provide strong similarity to similar feature descriptors and a high difference from dissimilar feature descriptors.

Additional feature descriptors may be created by aggregating and collecting feature descriptors into a pool using a clustering such as KMeans, maximum a-posteriori Dirichlet process mixtures, Latent Dirichlet Allocation, Gaussian expectation-maximization, and k-harmonic means. Feature descriptors mapped into an alternate space using this type of pooling technique may also be used as feature descriptors.

Neural nets may also be used as a means to collect and combine feature descriptors. One common method of creating a new feature descriptor is to combine a subset of feature descriptors as inputs to a neural net. The output of the neural net is often a category or meaningful grouping for the feature vectors. Once the neural net is stable, the next to last layer of the network is used as the feature descriptor.

3D models may be used to generate a multi-view 2D image collection. The multi-view images may be fed to a convolution neural network (CNN) to create a feature vector for the 3D model. The feature vector is then used either for classification or for 3D model retrieval from the collection. In effect, the feature vector is more closely related to a combined feature from multiple image feature vectors.

Feature descriptors may be extracted from multi-views 2D image collections generated from 3D models. These features may be hashed using Location Semantic Hashing (LSH) into bins that are the top matching 3D model feature descriptors. This method degrades the original 3D model into a format that is usable by current image search and index techniques.

### 3D Model Searching

2D feature descriptors such as SURF may be extended to be used in the context of 3D shapes, using feature descriptors such as Rotation-Invariant Feature Transform (RIFT). This creates 3D SURF descriptors that may be searched directly or used as the bases for feature vectors. The 3D model is voxelized and the 3D SURF descriptors are generated from the resulting pointcloud. These features are used to later classify the model.

Examples of 3D feature descriptors can include Point Feature Histogram (PFH), Surflet-Pair-Relation Histograms, Fast Point Feature Histogram (FPFH), Viewpoint Feature Histogram (VFH), Clustered Viewpoint Feature Histogram (CVFH), Normal Aligned Radial Feature (NARF), Radius-based Surface Descriptor (RSD), Ensemble of Shape Functions (ESF), Hough Tranform, 3D SURF, and others.

A Siamese CNN may be fed both a sketch, a matching or dissimilar model, and either a matching or dissimilar classification. The resulting system may take a sketch and match the sketch to a 3D model from a collection.

### Multi-view Generation

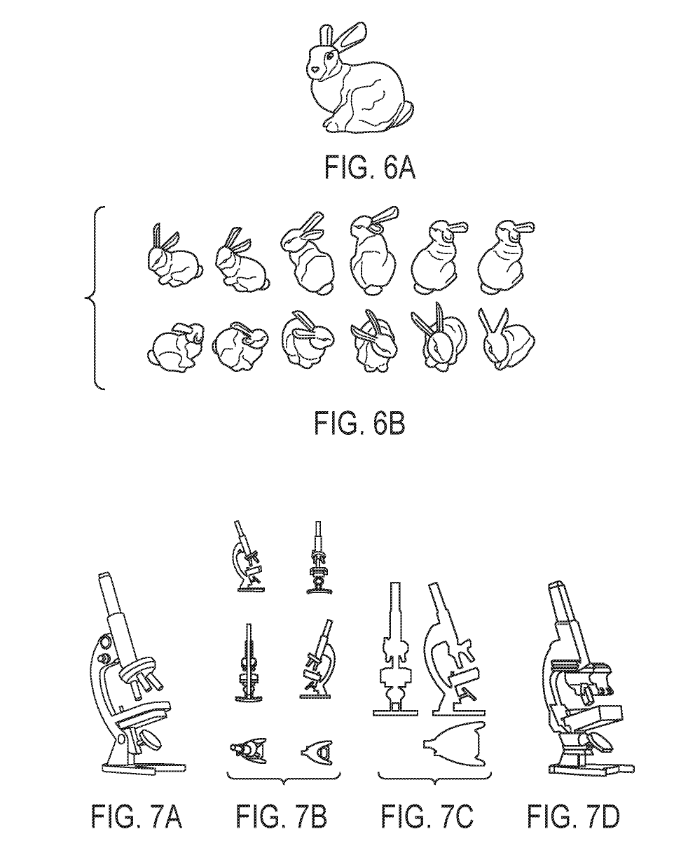

Consider the following example. A first set of multi-view images (shown in FIGS. 6A-6B) were captured of the model (FIG. 6A) from a fixed distance in 30 degree intervals at 0 inclination. A second and third round of images were captured at 30 degree intervals at a −45 and +45 degree inclination. The resulting 36 images form the basis of the multi-view collection for the specific model. Thus, FIG. 6A shows an image of the original model and FIG. 6B illustrates 12 of the multi-view images taken from 45 degree angles.

The second set of images constructed (Shown in FIGS. 7A-7D) were the standard six images described in the Patent Office Application Guide. The models were scaled to fit within a cube and images were taken from cameras at each face of the cube. These images form the basis for the 3D model reconstruction described next.

### 3D Model Reconstruction

The method used to reconstruct the 3D models from the multi-view images is the intersection of the silhouettes of the primary faces. Using the silhouettes provides assurance that the generated model does not exceed the boundary of the original object. While may be issues with occlusions and insufficient details, the resulting model is sufficient to form a basis for 3D model searching.

Having extracted the images that would simulate an image document set the images must next be reconstructed into a 3D model. To reconstruct a usable 3D model from the six views standard to the patent office design patent format the front, side and top view of the object are identified. Considering only the silhouette of the object, the silhouette of the bottom view is the mirror image of the top view, and therefore the silhouette of either the top view or the bottom view can be ignored. Silhouettes of these three views are then linearly extruded into 3D surfaces representing the primary faces of the model. Each of these surfaces represents the possible 3D object as seen from this orientation. When the three extruded objects are intersected, a new volume is created that represents the 3D object as a combination of the maximum possible outlines of the actual shape. FIGS. 7A-7D show the process of first deconstructing the 3D model (FIG. 7A) into a six view representation (FIG. 7B), finding the silhouettes of the representative sides (FIG. 7C), and the resulting 3D model generated from these multi-view images (FIG. 7D).

### Second Exemplary Method

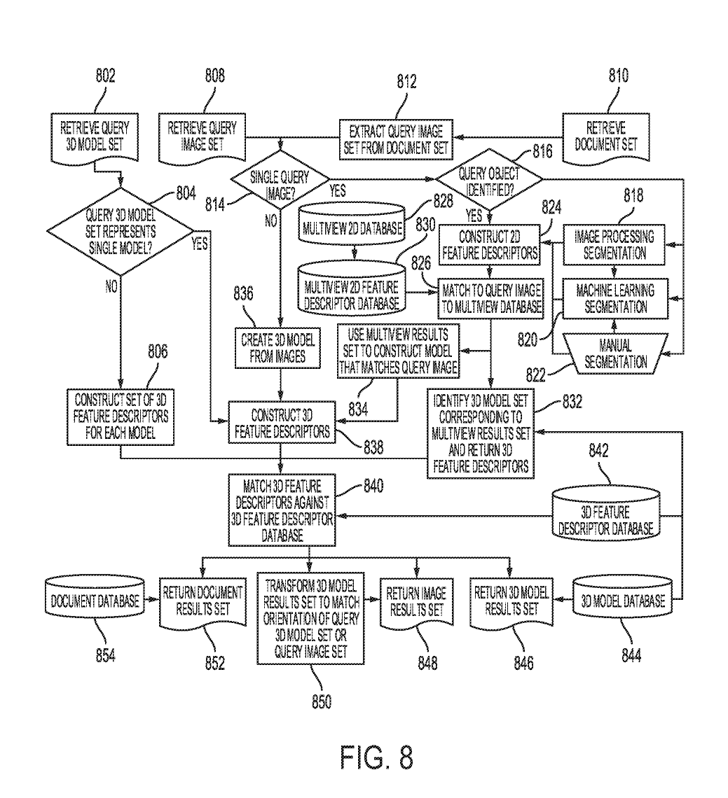

FIG. 8 illustrates a second exemplary method for a system configured according to this disclosure. As illustrated, this method can be initiated in multiple ways based on how the initial query is received. In each case, the goal is to provide similarity-based matches to the query using one or more databases of 2D images and/or 3D models. In a first case, the query received is a 3D model (802). If the query 3D model set received represents a single model (804), the system identifies features associated with that model (i.e., the system constructs 3D feature descriptors (838)). If the query 3D model set received represents multiple models, the system constructs sets of 3D feature descriptors for each model present in the query (806). Thus is the query contains four or five models, the system identifies features associated with each of the individual models. In some configurations, the system can also identify features shared across the multiple models. In some cases, those shared features can have a higher ranking or value for later searching than a feature found in only one of the queried 3D models.

In a second case, the system receives a query image set (808) of 2D images, whereas in other cases the system receives a document set (801) which may include data (such as metadata, text, or other description data) other than the images. In such cases, the system can extract query images from the document set (812). With the query image set (received directly (808) or extracted (812)), the system determines if the received 2D images are for a single query (814). If so, the system constructs a 3D model from the images (836) and constructs 3D feature descriptors of the 3D model (838).

However, if the query image set is not for a single query, the system determines if a query object has been identified (816). If not, the system performs image processing segmentation (818), machine learning segmentation (820), and/or manual segmentation (822) to separate and identify the respective objects being searched for. As illustrated, the image processing segmentation (818), machine learning segmentation (820), and manual segmentation (822) are shown in parallel. However, there can be configurations where the processes are performed serially, or even eliminated. For example, it may be more computationally efficient to run image processing first, then machine learning, and only then if the objects are still not segmented to signal to a user that manual segmentation may need to occur.

Segmentation, as disclosed herein, is the process of identifying objects to be modeled and searched for from other objects within an image or images and separating those objects so they can be effectively modeled. For example, if the query image set received 808 is for a mug, but images of the mug include pictures of a mug sitting on a desk or table, the segmentation process 818, 820, 822 will remove objects other than the mug from within the image set. In other words, objects within the image which are not the object-to-be-modeled and searched for (such as a table, a desk, papers near the mug, a person's hand holding the mug, etc.) will be identified and removed, such that only the mug remains. The system can use image processing (818) to identify which objects are which, with the image processing segmentation using databases and records of known images to identify, label, and/or extract the objects from within a given image. The machine learning segmentation (820) can iteratively learn, based on previous segmentations and modeling, new objects to be added to the image processing (818) library, as well as improved ways of performing the segmentation. Improving segmentation/object extraction using a machine learning process (820) which iteratively updates itself and the image processing segmentation (818) by using previous segmentations and modeling is a technical improvement over previous 2D to 3D segmentation processes.

With the multiple objects identified, the system then constructs 2D feature descriptors (824) on the images within the query image set. A multi-view 2D database (828) can work in conjunction with a multi-view 2D feature descriptor database (830) to provide known/archived features of 2D images, and the system can attempt to match the 2D features of the queried images to known features of 2D images. This comparison can, in some cases, reduce the necessity to generate the 3D model and perform subsequent comparisons. At the same time, however, such comparison can aid in identifying key features/components of the queried images in constructing a 3D model that matches the queried images (834). Likewise, the system can identify a 3D model set corresponding to the multi-view result set, and return the 3D feature descriptors based on the 2D feature matches (832). The 3D model results set can be determined using models stored in a 3D model database (844), and can be based on similarities of features between the generated 3D model and stored 3D models.

Having generated the 3D model and the feature descriptors for that model, the system can compare the 3D feature descriptors against archived 3D feature descriptors (840). Matches can then be returned in a response to the query. In the case of a document set query (810), the system can access a document database (854) and return a document results set (852) which includes the matched 3D models based on the matched feature descriptors. In the case of a 3D model query (802) or an image set query (808), the system can transform the 3D model results set to match the orientation of the queried 3D model or the queried image set (850). Likewise, the system can convert the 3D model result set into 2D images (848) and return those to the user. The system can also return the 3D model result set itself (846), accessing the 3D model database (844) to obtain copies of the models.

### Third Exemplary Method

A third exemplary method can include: receiving a query, the query comprising a plurality of two-dimensional images, each two-dimensional image in the plurality of two-dimensional images having a distinct multi-view perspective. The system can then generate, at a processor configured to generate a three-dimensional model from two-dimensional images, for each two-dimensional image in the plurality of two-dimensional images, a silhouette, to yield a plurality of silhouettes. The system can combine, via the processor, the silhouettes using the distinct multi-view perspective of each two-dimensional image, to yield a three-dimensional model, and compare the three-dimensional model to archived three-dimensional models, to yield a comparison. The system can then rank, via the processor and based on the comparison, the archived three-dimensional models by similarity to the three-dimensional model, to yield ranked similarity results, and respond to the query with the ranked similarity results.

In some configurations, the plurality of two-dimensional images are black-and-white drawings with uniformly thick lines. Similarly, in some configurations the plurality of two-dimensional images can be compliant with U.S. Patent and Trademark Office drawing guidelines, and/or compliant with U.S. Patent and Trademark Office guidelines for design patents, trademarks, or other protected subject matter.

In some configurations, the comparing of the three-dimensional model to archived three-dimensional models can include: for each respective archived three-dimensional model being compared to the three-dimensional model: identifying, via the processor, an initial plurality of features which are common between the three-dimensional model and the respective archived three-dimensional model; orienting the three-dimensional model and the respective archived three-dimensional model such that they share a common orientation; and removing outlier features within the initial plurality of features based on the outlier features no longer being shared between the three-dimensional model and the respective archived three-dimensional model when in the common orientation. In other configurations, the comparing can eliminate the removing of the outlier features, such that the comparing further includes: orienting the three-dimensional model and the respective archived three-dimensional model such that they share a common orientation; and identifying, via the processor, a plurality of features which are common between the three-dimensional model and the respective archived three-dimensional model when in the common orientation.

In some configurations, the method can further include: extracting features from the plurality of two-dimensional images, each feature in the features comprising an area within a two-dimensional image of the plurality of two-dimensional images which is statistically distinct from other portions of the two-dimensional image, where the features are used in the comparing of the three-dimensional model to the archived three-dimensional models. In such cases, the features can be used by the processor during the combining of the silhouettes using the distinct multi-view perspective of each two-dimensional image to form the three-dimensional model.

How one defines statistically distinct can vary based on particular circumstances or configurations, with the universal principle being to identify features which are uncommon or rare within the two-dimensional image or images. For example, in some configurations, each portion of an image can be ranked in various categories (shading, lighting, contrast, number of lines, etc.). The various portions of the image can be averaged out, such that portions which are unique, different, outliers, etc., can be identified as “statistically distinct.” In some configurations, such identifications can be based on a portion having values which are beyond a standard deviation of the mean, multiple standards of deviation, etc. In yet other configurations, the system can identify a portion as “statistically distinct” if it is the top ranked portion, or within a top few portions, for a given classification. For example, the system may rank portions of an entirety of two-dimensional image based on a categorization, as described above. The system can then select the highest ranking portions (such as the top portion, or the top five portions) for a given categorization as being “statistically distinct” based on their ranking, regardless of how similar those portions may be to other portions.

In some configurations, the comparing of the three-dimensional model to archived three-dimensional models can further include: comparing features of the three-dimensional model to archived features of the archived three-dimensional models, the archived features having been previously identified.

### Description of a Computer System

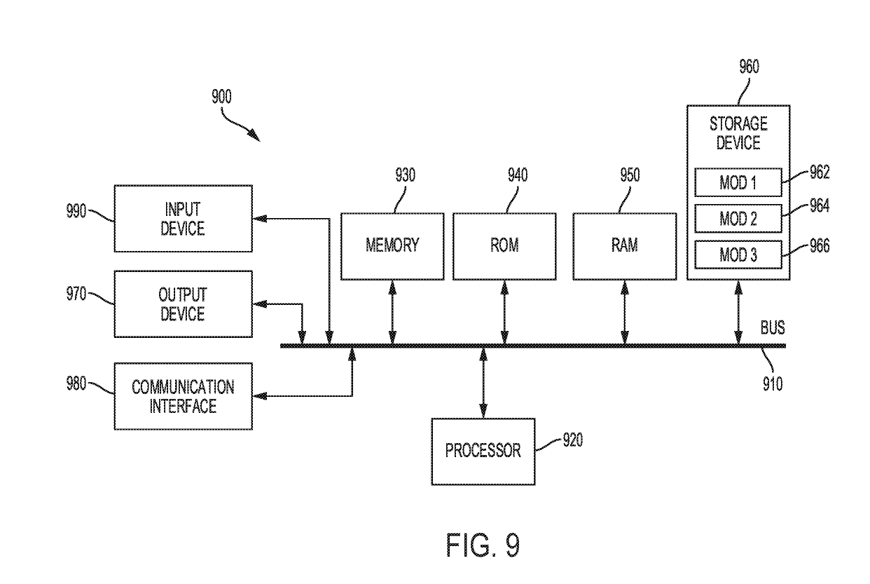

With reference to FIG. 9, an exemplary system 900 includes a general-purpose computing device 900, including a processing unit (CPU or processor) 920 and a system bus 910 that couples various system components including the system memory 930 such as read-only memory (ROM) 940 and random access memory (RAM) 950 to the processor 920. The system 900 can include a cache of high-speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, bus 910, display 970, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 900 is a small, handheld computing device, a desktop computer, or a computer server.

Although the exemplary embodiment described herein employs the hard disk 960, other types of computer-readable media which can store data that are accessible by a computer, such as magnetic cassettes, flash memory cards, digital versatile disks, cartridges, random access memories (RAMs) 950, and read-only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

The steps and systems outlined herein are exemplary and can be implemented in any combination thereof, including combinations that exclude, add, or modify certain steps.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving a query, the query comprising a plurality of two-dimensional images, each two-dimensional image in the plurality of two-dimensional images having a distinct multi-view perspective;
generating, at a processor configured to generate a three-dimensional model from two-dimensional images, for each two-dimensional image in the plurality of two-dimensional images, a silhouette, to yield a plurality of silhouettes;
combining, via the processor, the silhouettes using the distinct multi-view perspective of each two-dimensional image, to yield a three-dimensional model;
comparing, via the processor, the three-dimensional model to archived three-dimensional models, to yield a comparison; and
ranking, via the processor and based on the comparison, the archived three-dimensional models by similarity to the three-dimensional model, to yield ranked similarity results; and
responding to the query with the ranked similarity results.

2. The method of claim 1, wherein the plurality of two-dimensional images are black-and-white drawings with uniformly thick lines.

3. The method of claim 1, wherein the comparing of the three-dimensional model to archived three-dimensional models further comprises:
for each respective archived three-dimensional model being compared to the three-dimensional model:
identifying, via the processor, an initial plurality of features which are common between the three-dimensional model and the respective archived three-dimensional model;
orienting the three-dimensional model and the respective archived three-dimensional model such that they share a common orientation; and
removing outlier features within the initial plurality of features based on the outlier features no longer being shared between the three-dimensional model and the respective archived three-dimensional model when in the common orientation.

4. The method of claim 1, wherein the comparing of the three-dimensional model to archived three-dimensional models further comprises:
for each respective archived three-dimensional model being compared to the three-dimensional model:
orienting the three-dimensional model and the respective archived three-dimensional model such that they share a common orientation; and
identifying, via the processor, a plurality of features which are common between the three-dimensional model and the respective archived three-dimensional model when in the common orientation.

5. The method of claim 1, further comprising:
extracting features from the plurality of two-dimensional images, each feature in the features comprising an area within a two-dimensional image of the plurality of two-dimensional images which is statistically distinct from other portions of the two-dimensional image,
wherein the features are used in the comparing of the three-dimensional model to the archived three-dimensional models.

6. The method of claim 5, wherein the features are used by the processor during the combining of the silhouettes using the distinct multi-view perspective of each two-dimensional image to form the three-dimensional model.

7. The method of claim 1, wherein the comparing of the three-dimensional model to archived three-dimensional models further comprises:
comparing features of the three-dimensional model to archived features of the archived three-dimensional models, the archived features having been previously identified.

8. A system comprising:
a processor configured to generate a three-dimensional model from two-dimensional images; and
a computer-readable storage medium having instructions stored which, when executed by the processor, cause the processor to perform operations comprising:
receiving a query, the query comprising a plurality of two-dimensional images, each two-dimensional image in the plurality of two-dimensional images having a distinct multi-view perspective;
generating, for each two-dimensional image in the plurality of two-dimensional images, a silhouette, to yield a plurality of silhouettes;
combining the silhouettes using the distinct multi-view perspective of each two-dimensional image, to yield a three-dimensional model;
comparing the three-dimensional model to archived three-dimensional models, to yield a comparison; and
ranking, based on the comparison, the archived three-dimensional models by similarity to the three-dimensional model, to yield ranked similarity results; and
responding to the query with the ranked similarity results.

9. The system of claim 8, wherein the plurality of two-dimensional images are black-and-white drawings with uniformly thick lines.

10. The system of claim 8, wherein the comparing of the three-dimensional model to archived three-dimensional models further comprises:
for each respective archived three-dimensional model being compared to the three-dimensional model:
identifying, via the processor, an initial plurality of features which are common between the three-dimensional model and the respective archived three-dimensional model;
orienting the three-dimensional model and the respective archived three-dimensional model such that they share a common orientation; and
removing outlier features within the initial plurality of features based on the outlier features no longer being shared between the three-dimensional model and the respective archived three-dimensional model when in the common orientation.

11. The system of claim 8, wherein the comparing of the three-dimensional model to archived three-dimensional models further comprises:
for each respective archived three-dimensional model being compared to the three-dimensional model:
orienting the three-dimensional model and the respective archived three-dimensional model such that they share a common orientation; and
identifying, via the processor, a plurality of features which are common between the three-dimensional model and the respective archived three-dimensional model when in the common orientation.

12. The system of claim 8, the computer-readable storage medium having additional instructions stored which, when executed by the processor, cause the processor to perform operations comprising:
extracting features from the plurality of two-dimensional images, each feature in the features comprising an area within a two-dimensional image of the plurality of two-dimensional images which is statistically distinct from other portions of the two-dimensional image,
wherein the features are used in the comparing of the three-dimensional model to the archived three-dimensional models.

13. The system of claim 12, wherein the features are used by the processor during the combining of the silhouettes using the distinct multi-view perspective of each two-dimensional image to form the three-dimensional model.

14. The system of claim 8, wherein the comparing of the three-dimensional model to archived three-dimensional models further comprises:
comparing features of the three-dimensional model to archived features of the archived three-dimensional models, the archived features having been previously identified.

15. A non-transitory computer-readable storage medium having instructions stored which, when executed by a processor configured to generate a three-dimensional model from two-dimensional images, cause the processor to perform operations comprising:
receiving a query, the query comprising a plurality of two-dimensional images, each two-dimensional image in the plurality of two-dimensional images having a distinct multi-view perspective;
generating, for each two-dimensional image in the plurality of two-dimensional images, a silhouette, to yield a plurality of silhouettes;
combining the silhouettes using the distinct multi-view perspective of each two-dimensional image, to yield a three-dimensional model;
comparing the three-dimensional model to archived three-dimensional models, to yield a comparison; and
ranking, based on the comparison, the archived three-dimensional models by similarity to the three-dimensional model, to yield ranked similarity results; and
responding to the query with the ranked similarity results.

16. The non-transitory computer-readable storage medium of claim 15, wherein the plurality of two-dimensional images are black-and-white drawings with uniformly thick lines.

17. The non-transitory computer-readable storage medium of claim 15, wherein the comparing of the three-dimensional model to archived three-dimensional models further comprises:
for each respective archived three-dimensional model being compared to the three-dimensional model:
identifying, via the processor, an initial plurality of features which are common between the three-dimensional model and the respective archived three-dimensional model;
orienting the three-dimensional model and the respective archived three-dimensional model such that they share a common orientation; and
removing outlier features within the initial plurality of features based on the outlier features no longer being shared between the three-dimensional model and the respective archived three-dimensional model when in the common orientation.

18. The non-transitory computer-readable storage medium of claim 15, wherein the comparing of the three-dimensional model to archived three-dimensional models further comprises:
for each respective archived three-dimensional model being compared to the three-dimensional model:
orienting the three-dimensional model and the respective archived three-dimensional model such that they share a common orientation; and
identifying, via the processor, a plurality of features which are common between the three-dimensional model and the respective archived three-dimensional model when in the common orientation.

19. The non-transitory computer-readable storage medium of claim 15, having additional instructions stored which, when executed by the processor, cause the processor to perform operations comprising:
extracting features from the plurality of two-dimensional images, each feature in the features comprising an area within a two-dimensional image of the plurality of two-dimensional images which is statistically distinct from other portions of the two-dimensional image,
wherein the features are used in the comparing of the three-dimensional model to the archived three-dimensional models.

20. The non-transitory computer-readable storage medium of claim 19, wherein the features are used by the processor during the combining of the silhouettes using the distinct multi-view perspective of each two-dimensional image to form the three-dimensional model.
